(19) United States
(12) Patent Application Publication
(10) Pub. No.: US 2015/0261688 A1
(43) Pub. Date: Sep. 17, 2015

(54) EXTENDED PAGE TABLE FOR I/O ADDRESS TRANSLATION

(71) Applicant: International Business Machines Corporation, Armonk, NY (US)

(72) Inventors: David Craddock, New Paltz, NY (US); Thomas A. Gregg, Highland, NY (US); Dan F. Greiner, San Jose, CA (US); Eric N. Lais, Tillson, NY (US)

(73) Assignee: International Business Machines Corporation, Armonk, NY (US)

(21) Appl. No.: 14/210,968

(22) Filed: Mar. 14, 2014

(51) Int. Cl. G06F 12/10; G06F 12/14; G06F 13/40; G06F 12/08

(52) U.S. Cl. CPC G06F 12/1081; G06F 12/0866; G06F 12/1483; G06F 13/4022; G06F 2212/1052; G06F 2212/284; G06F 2212/303

(57) ABSTRACT

An extension of a page table is provided. An aspect includes receiving, by a host bridge, a request. An aspect includes determining, by the host bridge, that access to a memory address space referenced by the request is authorized based on a requester identifier associated with the request. An aspect includes, based on determining that access to the memory address space is authorized, accessing, by the host bridge, a page included in the memory address space based on a combination of: a start of the page table and a single extended index.

### BACKGROUND

The present invention relates generally to computing technology, and more specifically, to an extended page table for input/output (I/O) address translation.

The peripheral component interconnect (PCI) is a local computer bus for attaching hardware devices in a computer. Host bridges are used to interface or bridge PCI interfaces/buses and processor buses and system memory. Host bridges provide a number of functions, one of which is an address translation from a PCI address to a system memory address.

In order to provide address translation, typically the bridges use page tables of a fixed size. Typically, that size corresponds to a fixed page size for a system. Providing address spaces, such as direct memory access (DMA) address spaces (DMAASs), larger than can be addressed by this fixed page table requires additional levels of translation (e.g., segment tables, region tables, etc.). Using the additional levels of translation impairs performance, as multiple fetches are required by a host bridge in order to translate a single PCI address.

In order to translate a virtual address, portions of the address are used as indices into translation tables in contiguous real memory. A problem in earlier operating systems was the difficulty of assembling a large area of real memory (due to the fragmentation that is inherent in memory assignment).

In newer systems having much larger amounts of real memory, such fragmentation issues have become less significant. Thus, where tables in older systems may have been limited to 4 K-bytes (in ESA/390) or 16 K-bytes (in z/architecture), modern systems can easily assemble a contiguous block of 1 M-byte real storage. With that in mind, the need to break up virtual addresses into smaller indices is minimized. The table space can be larger, thus the scope of a particular virtual index can also be larger.

### SUMMARY

Embodiments include a method, system, and computer program product for extending a page table. In an embodiment, a method comprises receiving, by a host bridge, a request. The method comprises determining, by the host bridge, that access to a memory address space referenced by the request is authorized based on a requester identifier associated with the request. Based on determining that access to the memory address space is authorized, the method comprises accessing, by the host bridge, a page included in the memory address space based on a combination of: a start of the page table and a single extended index.

In an embodiment, a computer program product for extending a page table is provided. The computer program product comprises a tangible storage medium readable by a processing circuit and storing instructions for execution by the processing circuit for performing a method. The method comprises receiving, by a host bridge, a request. The method comprises determining, by the host bridge, that access to a memory address space referenced by the request is authorized based on a requester identifier associated with the request. Based on determining that access to the memory address space is authorized, the method comprises accessing, by the host bridge, a page included in the memory address space based on a combination of: a start of the page table and a single extended index.

In an embodiment, a computer system for extending a page table is provided. The system comprises a memory having computer readable instructions. The system comprises a processor configured to execute the computer readable instructions. The instructions comprise receiving a request. The instructions comprise determining that access to a memory address space referenced by the request is authorized based on a requester identifier associated with the request. The instructions comprise, based on determining that access to the memory address space is authorized, accessing a page included in the memory address space based on a combination of: a start of the page table, a first offset associated with the request that corresponds to a group of page table entries in the page table, and a second offset associated with the request that corresponds to an entry in the page table within the group and a single extended index.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1A depicts a computing system environment in accordance with an embodiment;

FIG. 1B depicts a computing system environment in accordance with an embodiment;

FIG. 2 depicts a system for extending a page table to translate an input/output address in accordance with an embodiment; and

FIG. 3 depicts a process flow for extending a page table to translate an input/output address in accordance with an embodiment.

### DETAILED DESCRIPTION

In accordance with one or more embodiments, systems, apparatuses, and methods are described that provide contiguous pages for an extended page table. In this manner, a single-level lookup is provided for all translations within an expanded address space (e.g., an expanded direct memory access address space (DMAAS).

In accordance with one or more embodiments, a DMAAS is extended while maintaining a single-level input/output (I/O) address translation. The page table is extended by using contiguous pages or frames. In other words, no special alignment is required relative to the entire DMAAS, with the possible exception of page/frame alignment. Multiple page/frame sizes are supported for both the DMAAS and the page table. The DMAAS is bounds checked by using a base or start address and a limit or end address in a device table entry (DTE). An I/O translation anchor (IOTA) in the DTE provides an indication of whether extended translation is provided and a starting address for a page table. An extended page index (EPX) uses selected bits from a PCI address, based on a frame size, to select a group of pages included in the page table. A page index (PX) uses selected bits from the PCI address, based on the frame size, to select a page included in the selected group of pages.

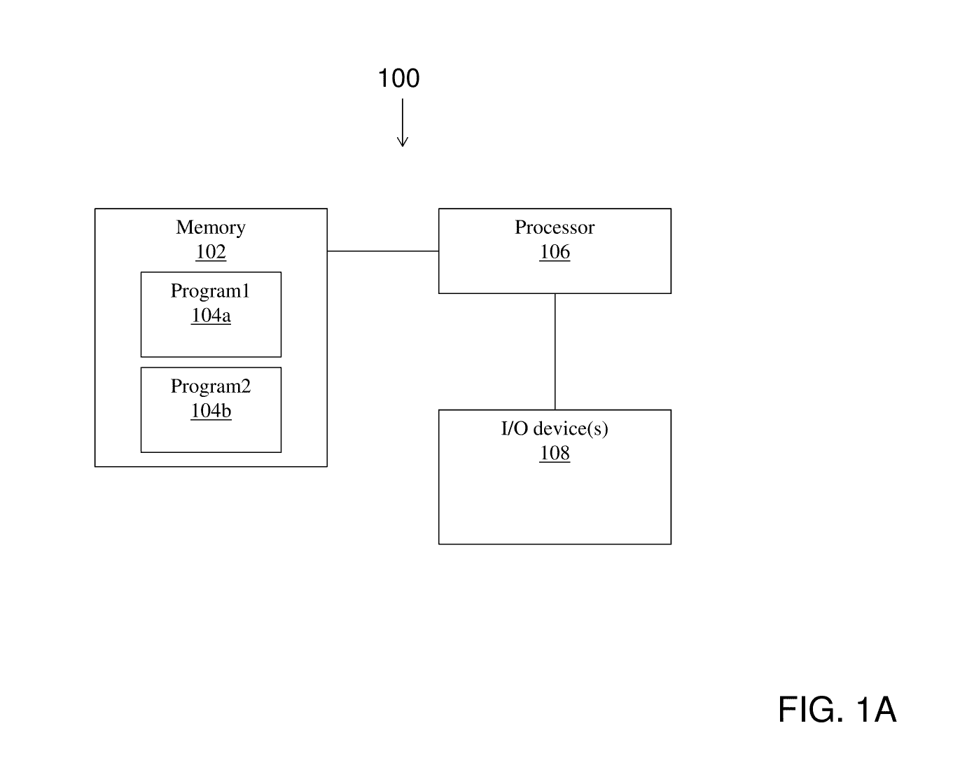

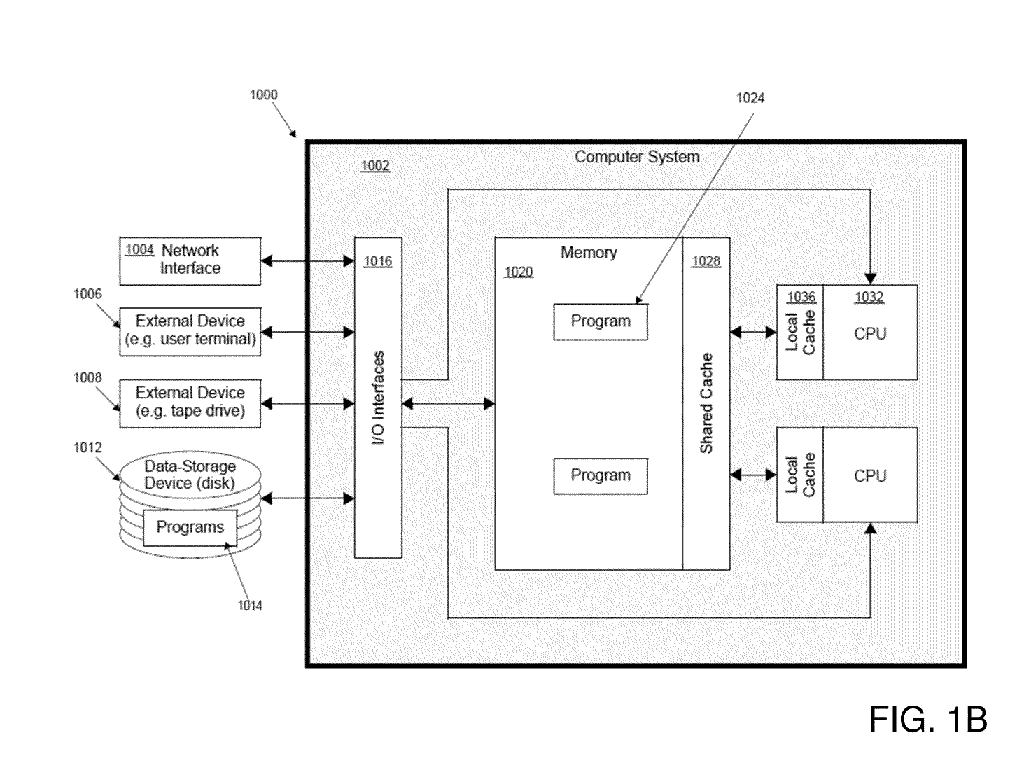

Referring to FIG. 1A, an exemplary computing system 100 is shown. The system 100 is shown as including a memory 102. The memory 102 may store executable instructions. The executable instructions may be stored or organized in any manner and at any level of abstraction, such as in connection with one or more applications, processes, routines, procedures, methods, etc. As an example, at least a portion of the instructions are shown in FIG. 1A as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a network adapter, a telephone or mobile device (e.g., a smartphone), a sensor, etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1A.

FIG. 1B shows a system 1000 in accordance with one or more embodiments. In particular, the system 1000 includes a computer system 1002. The computer system 1002 may include one or more components or devices, such as one or more I/O interfaces 1016. The I/O interface 1016 may be coupled to one or more processors, such as one or more CPUs 1032. Each of the CPUs 1032 may be associated with one or more caches 1036. The I/O interface 1016 and the caches 1036 may couple to a memory or memory device 1020. The memory device 1020 may store one or more programs 1024. The programs 1024 may be executed to perform one or more methodological acts, such as those described herein. The memory 1020 may be associated with a shared cache 1028. The shared cache 1028 may be accessed by the caches 1036 and/or the CPUs 1032 to store and share, e.g., data.

The computer system 1002/I/O interface 1016 may be coupled to one or more interfaces or devices. For example, a network interface 1004 may be used to provide networking support in connection with one or more networks. An external device 1006 may include one or more devices that may interface to the computer system 1002, such as a user terminal. As yet another example of an external device, a tape drive 1008 may be included. In some embodiments, a storage device 1012 may be included. The storage device 1012 may include one or more disks. The storage device 1012 may be used to store programs 1014 that may optionally be executed by the computer system 1002.

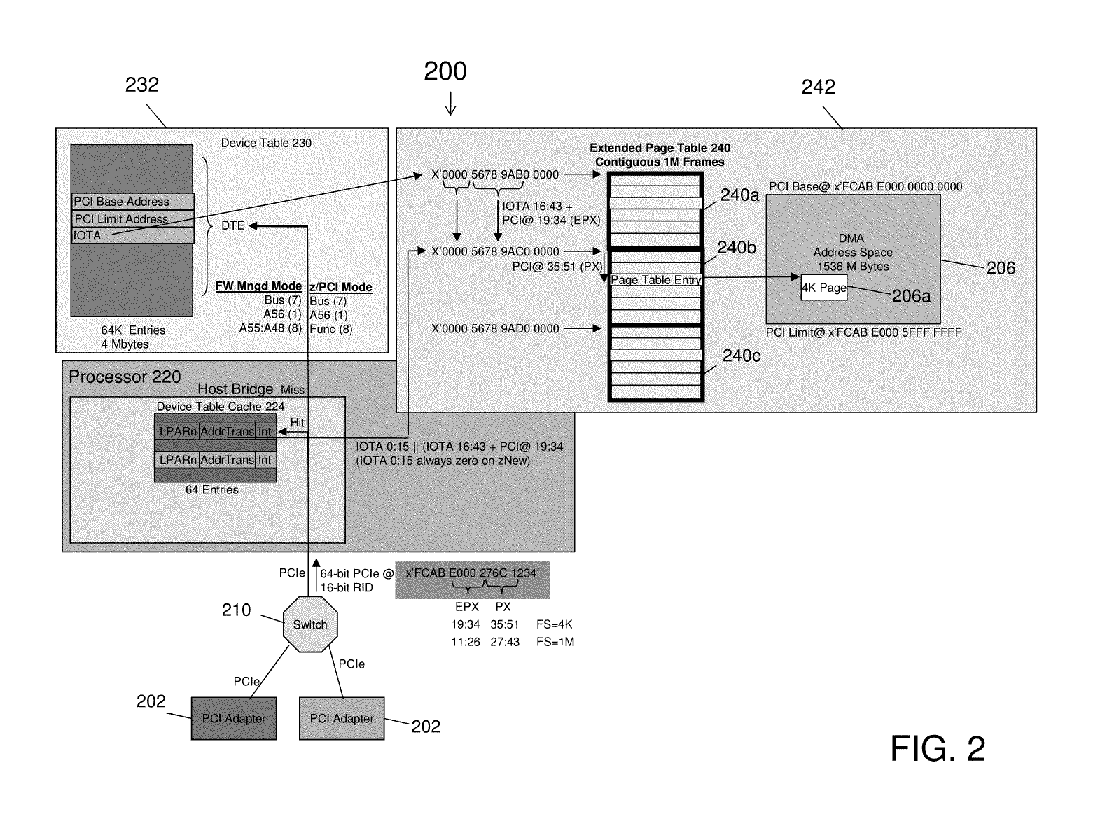

Referring now to FIG. 2, a system 200 is shown. The system 200 may be used to provide one or more PCI adapters 202, or PCI functions associated with the PCI adapter 202, access to a DMAAS 206. In the embodiment of FIG. 2, the address space 206 is shown as a DMAAS of 1536 Megabytes composed of 4 Kbyte pages 206a. The 1536 Megabytes may represent the difference between a PCI base address and a PCI limit address included in, e.g., a device table 230 as described further below. A different size address space 206 and/or a different page 206a size may be used in some embodiments.

A PCI adapter 202 may request access to the DMAAS 206 in connection with a read or write operation. The request may be routed over PCI (or, analogously, over PCI Express (PCIe)) to a switch 210, such as PCIe switch.

The PCI request may include or reference a requester identifier (RID), which in the embodiment shown in FIG. 2 is sixteen bits in length. The RID may serve to identify or distinguish the PCI function or PCI adapter 202 issuing the request from other devices, such as other PCI functions or PCI adapters 202.

The PCI request may include or reference an address. The address is shown in FIG. 2 as being sixty-four bits in length and having a value ‘FCAB E000 276C 1234’ in a hexadecimal base, where bits positions 0-3 (e.g., the left-most bits) may correspond to the ‘F’ value and bit positions 60-63 (e.g., the right-most bits) may correspond to the ‘4’ value. Of course, the orientation of the bits in a given embodiment may be modified from this example in terms of, e.g., the location of the most or least significant bits.

A PCI base address may be used to calculate an offset (received PCI address minus the PCI base address), which can then be used as an index into the tables (EPX/PX, described further below). In order to simplify the calculation of this offset and avoid performing subtraction in hardware, a rule may be imposed that the PCI base address must be either 32 Tbyte aligned for 4K pages or 8 Pbyte aligned for 1M frames, in which case the low order bits of the base are guaranteed to be zeroes. This alignment can be enforced when the DMAAS 206 is registered and the PCI base address/limit and IOTA are provided and programmed into the DTE.

The PCI address may include an extended page index (EPX) and page index (PX) fields as shown in FIG. 2. When the DMAAS 206 is composed of 4 Kbyte pages as shown in FIG. 2, the EPX consumes bit positions 19-34 in the address offset and the PX consumes bit positions 35-51 in the address offset. On the other hand, when the address space is composed of 1 Megabyte pages, the EPX consumes bit positions 11-26 in the address offset and the PX consumes bit positions 27-43 in the address offset. Of course, other positions are possible based on the size of the extended page table or the size of the pages within the address space.

The request may be provided by the switch 210 to a processor 220, such as a zProcessor provided by the International Business Machines Corporation. The processor 220 may correspond to the processor 106 of FIG. 1A or a processor 1032 of FIG. 1B in some embodiments. As a preliminary matter, the request may be compared to a device table cache 224 to determine if the request has previously been serviced, such that an entry is still present in the cache 224 when the request is received by the processor 220. If the entry is present in the cache 224 (a so-called cache “hit”), then an extended page table 240 may be accessed using the cache entry. Otherwise, if the entry is not present in the cache 224 when the request is received by the processor 220 (a so-called cache “miss”), the request may be routed from the processor 220 to a device table 230.

The device table 230, which may be included in system memory 232, may include a number of entries, each denoted as a device table entry (DTE). In one embodiment shown in FIG. 2, the device table 230 may comprises 65,536 entries, each of which is 64 bytes in length (thus a total of 4 megabytes). Once the DTE is recognized/accessed, the information associated with the DTE may be inserted in the cache 224 to facilitate future cache hits for that DTE.

An example DTE is shown in FIG. 2. The DTE may include a number of fields, such as interrupt-based fields that may facilitate bridging of PCI message signaled interruptions generated by a PCI adapter 202 to an interruption architecture of the processor 220. For purposes of this disclosure, the PCI base address, PCI limit address and I/O translation anchor (IOTA) fields are described in greater detail below.

Upon receiving the request, the host bridge using the device table 230 may determine if the adapter 202 is authorized to access the DMAAS 206. Such a determination may be based on the RID, whereby the RID is used to locate the DTE associated with the PCI function issuing the request. For example, access to the DMAAS 206 may be restricted based on access information stored in the DTE as part of a registration process. The bounds of the DMAAS 206 may be established by the PCI base address and PCI limit address fields in the DTE. In addition, access controls such as read-only access may also be specified.

If the address translation and protection checks performed on the request from the adapter 202 indicate memory access is not permitted, the request may be denied and the adapter 202 might not gain access to the DMAAS 206.

If the address translation and protection checks performed on the request from the adapter 202 indicate memory access is permitted, then the IOTA field of the DTE may be examined. The IOTA field may include one or more format bit(s) or indicator(s). The format indicator(s) may signify whether address translation in accordance with aspects of this disclosure is provided for. In this respect, backwards compatibility may be provided for legacy platforms that do not support extended address translation in the manner described herein.

If the format bit(s) of the IOTA field in the DTE indicate that extended address translation is supported, then other bits in the IOTA may serve to point to the start or beginning of an extended page table 240. The extended page table 240, which may be included in operating system (OS) memory 242, may be composed of groups of page table entries. For example, in FIG. 2 the extended page table 240 includes groups 240a, 240b, and 240c.

The EPX field associated with the (PCI) address included in the request may serve to select one of the groups 240a through 240c. In this respect, the value associated with the EPX field may serve as an offset relative to the pointer to the page table 240 associated with the IOTA. In the embodiment of FIG. 2, the EPX field causes the group 240b to be referenced. The groups 240a-240c may be described as a single, extended-size page table.

The PX field associated with the (PCI) address included in the request may serve to select an entry in the page table within the group selected by the EPX field. In this respect, the value associated with the PX field may serve as an offset relative to a combination of: (1) a portion of the IOTA, and (2) the EPX field. The combination of: (1) the portion of the IOTA, (2) the EPX field, and (3) the PX field may result in the requested access being granted to the page 206a in the DMAAS 206. To the extent that the groups 240a-240c may be described as a single, extended-size page table, the combination of the EPX and PX fields may also be described as a single object or single extended index.

After the page table entry has been located as described above, the DMA operation to or from the OS memory 242 is performed by using the page table entry as the page address and then offset using the low order 12 bits of the received PCI address for a 4K page.

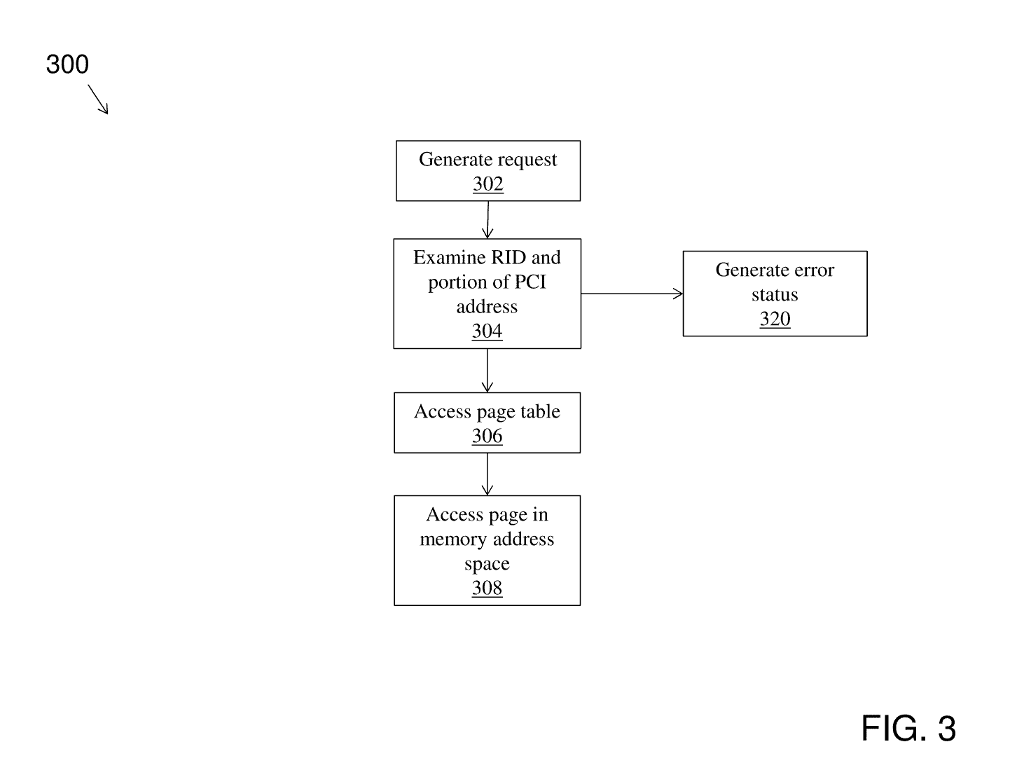

Turning to FIG. 3, a flow chart of a method 300 is shown. The method 300 may be executed by one or more systems, devices, or components, such as those described herein. An execution of the method 300 may serve to extend a page table for I/O address translation relative to conventional platforms and techniques when such extension capability is supported.

In block 302, a request for memory access may be generated. For example, a PCI adapter (or associated PCI function) may generate the request. The request may include an RID and an address, such as a PCI address. The request may include a specification of one or more read or write operations to perform with respect to a memory address space. The request may be received by one or more entities, such as a host bridge.

In block 304, the RID and a portion of the PCI address may be used to locate the DTE and the associated access rights to determine if the PCI adapter has permission to access the DMAAS referenced by the PCI address. If the PCI adapter does not have such permission, flow may proceed from block 304 to block 320, wherein an error status may be generated. Otherwise, if the PCI adapter does have permission, flow may proceed from block 304 to block 306.

In block 306, a page table entry may be accessed based on a combination of: (1) a portion of an IOTA field, (2) a value of an EPX field included in the PCI address, and (3) a value of a PX field included in the PCI address. The access to the page table entry may be taken from a cache if: (1) a cache is available, and (2) an entry associated with the request is present in the cache (e.g., a cache “hit”). Otherwise (e.g., a cache “miss”), the access to the page table entry may be provided in consultation with a device table or DTE.

In block 308, a page in memory address space may be accessed based on the page table entry of block 306 and a page offset in a portion of the PCI address.

The method 300 is illustrative. In some embodiments, one or more of the blocks, or a portion thereof, may be optional. In some embodiments, additional blocks or operations not shown may be included. In some embodiments, the blocks may execute in an order or sequence that is different from what is shown in FIG. 3.

Technical effects and benefits include the use of contiguous pages for an extended page table that provides for a single-level lookup for all translations within an expanded DMA address space. An expandable page table is provided to facilitate larger DMA address spaces without additional levels of translation and without a restriction of requiring the page table to be constrained to a power-of-two boundary.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-15. (canceled)

16. A computer system for extending a page table, the system comprising:
a memory having computer readable instructions; and
a processor configured to execute the computer readable instructions, the instructions comprising:
receiving a request;
determining that access to a memory address space referenced by the request is authorized based on a requester identifier associated with the request; and
based on determining that access to the memory address space is authorized, accessing a page included in the memory address space based on a combination of: a start of the page table, a first offset associated with the request that corresponds to a group of page table entries in the page table, and a second offset associated with the request that corresponds to an entry in the page table within the group and a single extended index.

17. The computer system of claim 16, wherein the instructions comprise:
determining that access to the memory address space is authorized based on a portion of an address associated with the request.

18. The computer system of claim 16, wherein the instructions comprise:
determining that the access to the memory address space referenced by the request is authorized based on determining that access controls within a device table entry permit access.

19. The computer system of claim 16, wherein the instructions comprise:
receiving the request from a switch associated with a peripheral component interconnect adapter.

20. The computer system of claim 16, wherein the memory address space is a direct memory access address space, and wherein the instructions comprise:
accessing the page included in the direct memory access address space based on determining that a format indicator indicates that extended translation is provided, and
wherein the single extended index is based on a first offset associated with the request that corresponds to a group of page table entries in the page table and a second offset associated with the request that corresponds to an entry in the page table within the group.
